(19) United States
(12) Patent Application Publication
(10) Pub. No.: US 2026/0330771 A1
(43) Pub. Date: Oct. 22, 2026

(54) System and Method for Viewing Large-Scale 3D City Models in Resource-Constrained Environments

(71) Applicant: Vizzio Technologies Pte. Ltd., Singapore (SG)

(72) Inventor: Seng Fook LEE, Singapore (SG)

(21) Appl. No.: 19/655,678

(22) Filed: Apr. 22, 2026

Related U.S. Application Data
(60) Provisional application No. 63/792,330, filed on Apr. 22, 2025.

(51) Int. Cl. G06T 19/00

(52) U.S. Cl. CPC G06T 19/00

(57) ABSTRACT

The present disclosure relates to a comprehensive system and method for effectively viewing large-scale 3D city models in resource-constrained environments. The combination of a compact data representation, LoD rendering, adaptive streaming, and other optimisation techniques enables real-time visualization and interaction with complex 3D city models, overcoming the limitations of conventional approaches. This technology has significant potential for various applications in industries such as urban planning, real estate, tourism, and entertainment.

### CROSS-REFERENCE

The present disclosure claims the benefit of US Provisional Applications Ser. No. 63/792,330, filed on Apr. 22, 2025, which is herein incorporated by reference in its entirety for all purposes.

### FIELD OF THE INVENTION

The present disclosure relates generally to computer graphics. In particular, the present disclosure relates 3D city modelling, rendering, and visualization techniques for resource-constrained environments.

### BACKGROUND

The development of 3D city models has become increasingly important for urban planning, navigation, and disaster management. Traditional methods for viewing these models require substantial computational resources, which limits their accessibility in resource-constrained environments such as mobile devices or low-power computers.

Traditional 3D models often comprise millions of polygons or other complex primitives, demanding significant memory and processing power to render, making them unsuitable for resource-limited devices.

Existing Level-of-Detail (LoD) techniques for simplifying models often introduce noticeable visual artefacts and discontinuities, particularly during transitions between detail levels.

Network bandwidth limitations can hinder the efficient delivery and streaming of large 3D city model data to client devices.

From the foregoing discussion, there is a desire to provide a solution for viewing large-scale 3D city models in environments with limited computational resources, such as mobile devices or web browsers.

### SUMMARY

Method and systems for efficiently viewing large-scale 3D city models in environments with limited computational resources are disclosed. In one embodiment, the system utilizes data compression techniques and level-of-detail (LOD) management to reduce the computational load while maintaining visual fidelity. It integrates low-resolution textures with procedural generation techniques to enhance model detail without significant resource consumption.

The system employs a combination of efficient data representation, level-of-detail rendering, and adaptive streaming to enable real-time visualization and navigation of complex 3D city models without exceeding memory or processing limitations.

These and other advantages and features of the embodiments herein disclosed will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present disclosure are described with reference to the following drawings, in which:

FIG. 1 shows an embodiment of a software framework that allows users to interact with 3D city models on devices with limited processing power.

### DETAILED DESCRIPTION

Embodiments described herein generally relate to systems and methods for viewing large-scale 3D city models in environments with limited computational resources. In one embodiment, the system employs data compression, utilizing advanced algorithms to compress geometric data without losing critical information, thereby enabling faster data transmission and reduced storage requirements; level-of-detail (LOD) management by implementing dynamic LOD adjustments based on user interaction and device capabilities to ensure smooth rendering by prioritizing essential model elements; and procedural generation, enhancing visual details using procedural textures and geometry generated on-the-fly, reducing the need for high-resolution pre-stored data. Together, they deliver efficient rendering without compromising visual quality, enabling real-time interaction with complex urban models on devices with low-power.

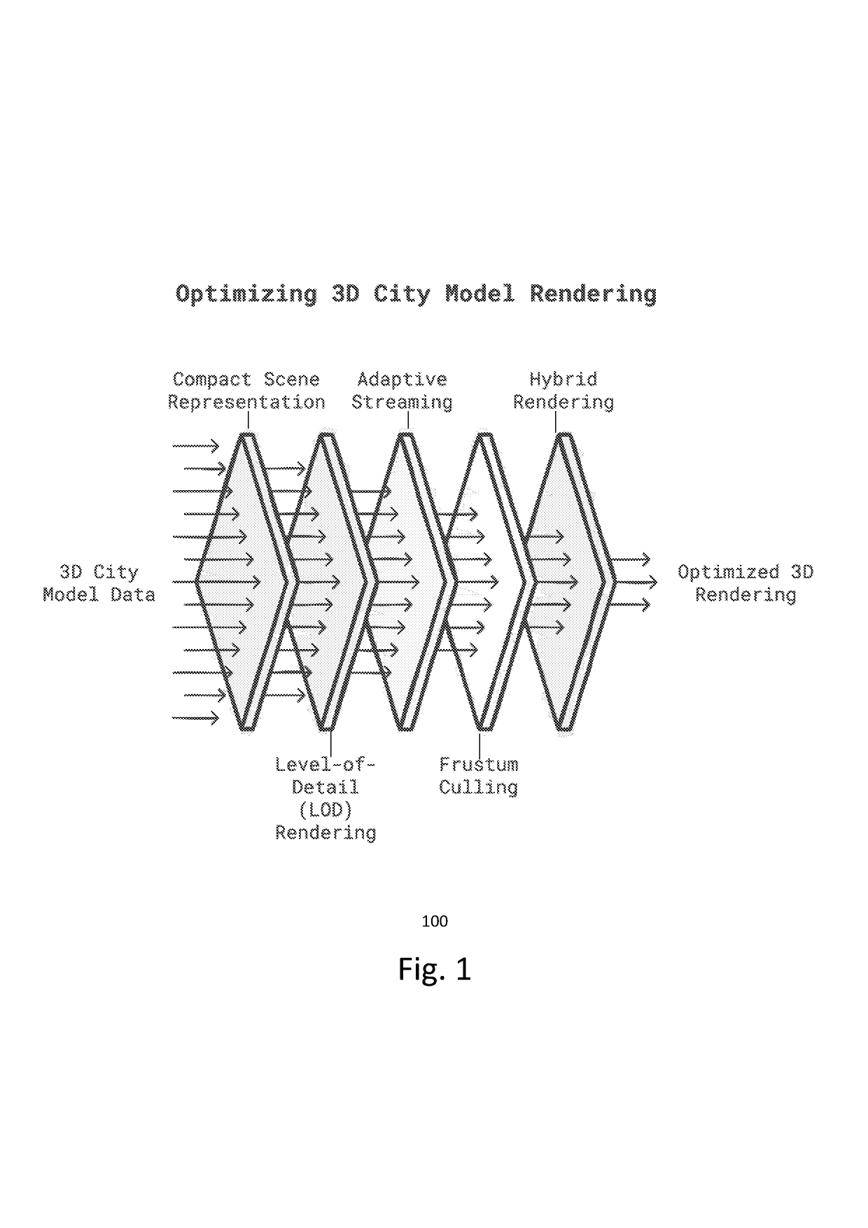

FIG. 1 shows an embodiment of a software framework 100 that allows users to interact with 3D city models on devices with limited processing power. The software framework processes the 3D city model data through multiple stages, including Compact Scene Representation, Level-of-Detail Rendering, Adaptive Streaming, Frustum Culling, and Hybrid Rendering to produce an optimized 3D rendering for interactive use.

Compact Scene Representation: The 3D city model is represented using an efficient format like 3D Gaussian Splatting (3DGS), where the scene is described using a collection of Gaussian primitives. These primitives are stored in a data storage unit and further grouped into spatially adjacent blocks, allowing for selective loading and processing of only the visible portions of the city.

Level-of-Detail (LoD) Rendering: The system employs a block-wise LoD strategy to adaptively adjust the level of detail for each block based on its distance from the viewer and its projected screen space. This strategy dynamically reduces the number of Gaussian primitives rendered for distant or less important blocks, significantly decreasing the computational load without sacrificing visual fidelity.

Adaptive Streaming: The 3D city model data is segmented into smaller chunks and stored in the data storage unit, from which it is streamed progressively to the client device based on the viewer's current position and viewing direction. This approach minimizes the initial data download and reduces the memory footprint on the client device.

Frustum Culling: The system uses frustum culling to exclude Gaussian blocks that are entirely outside the viewer's field of view, further optimising the rendering process by avoiding computations for invisible elements.

Hybrid Rendering: The system allows for a hybrid rendering approach, combining rasterisation of Gaussian primitives with ray tracing for select elements or areas where higher visual fidelity is required. This flexibility provides a balance between speed and quality, tailored to the specific needs of the application.

The software framework can be implemented in various ways to suit different platforms and use cases:
Mobile Applications: Developing mobile applications for urban planning, tourism, or gaming that leverage this technique to enable interactive 3D city visualization on smartphones and tablets.
Web-based Visualization Platforms: Creating web-based platforms for showcasing 3D city models with real-time navigation and interaction, accessible through standard web browsers.
Virtual Reality (VR) and Augmented Reality (AR) Systems: Integrating this technology into VR and AR applications to provide immersive and resource-efficient experiences of 3D city environments.

The software framework has broad applicability across multiple industries:
Architecture and Urban Planning: Facilitating interactive exploration and analysis of large-scale urban designs and development plans.
Real Estate and Property Marketing: Enabling virtual tours and presentations of complex property developments on resource-constrained devices.
Tourism and Navigation: Providing interactive 3D city guides and navigation aids for tourists on mobile devices.
Gaming and Entertainment: Developing immersive and dynamic 3D city environments for games and simulations that run smoothly on various devices.

The inventive concept of the present disclosure may be embodied in other specific forms without departing from the spirit or essential characteristics thereof. The foregoing embodiments, therefore, are to be considered in all respects illustrative rather than limiting the invention described herein.

What is claimed is:

1. A system for viewing a large-scale 3D city model in a resource-constrained environment, the system comprising:
a data storage unit configured to store the 3D city model in a compact format using a collection of Gaussian primitives;
a rendering unit configured to render the 3D city model using a block-wise Level-of-Detail (LoD) strategy;
a streaming unit configured to adaptively stream portions of the 3D city model to the resource-constrained environment based on the viewer's position and viewing direction.
